(19) United States
(12) Patent Application Publication
(10) Pub. No.: US 2020/0211017 A1
(43) Pub. Date: Jul. 2, 2020

(54) A SYSTEM FOR MANAGING CONFIDENTIAL INFORMATION DURING A TRANSACTION

(71) Applicant: IDAZ09 PTY LTD, Victoria (AU)

(72) Inventor: Goran NIKOLIC, Victoria (AU)

(73) Assignee: IDAZ09 PTY LTD, Victoria (AU)

(21) Appl. No.: 16/624,103

(22) PCT Filed: Jul. 2, 2018
(86) PCT No.: PCT/AU2018/000110

§ 371 Date: Dec. 18, 2019

(30) Foreign Application Priority Data
Jun. 30, 2017 (AU) 2017902541
Jul. 3, 2017 (AU) 2017902587
Feb. 8, 2018 (AU) 2018900400

(51) Int. Cl. G06Q 20/40; G06Q 20/36; G06Q 50/26

(52) U.S. Cl. CPC G06Q 20/4014; G06Q 50/265; G06Q 20/363

(57) ABSTRACT

The present invention is a system of providing a transaction to a person including an identity instrument, and a master database, wherein the identity instrument is issued to the person by the system under the authority of the prevailing government within a jurisdiction, and wherein the identity instrument is either virtual or physical or both, and wherein the transaction may be any governmental, commercial or charitable transaction, and wherein the master database maintains a record for each person issued with an identity instrument and when their identity instrument is used by the person, its use identifies that person's record within the master database and enables the system to retrieve the minimum amount of personal data relating to that person so that the particular transaction is able to proceed.

### FIELD OF THE INVENTION

This invention relates to identity systems that maintain secure and private information relating to individuals and entities registered on the system. The system includes disclosure management controls that only reveal the necessary information relating at least to an individual registered on a system to another individual or entity wishing to enter into a transaction with that individual.

### BACKGROUND OF THE INVENTION

The world is experiencing a continuous and significant increase in the number and variety of services going online, including businesses, government agencies and departments, and non-profit entities. These online services offer convenience and significantly increase data processing efficiency for the service provider. They also offer enhanced data integrity and security to the user. Often these types of services enable a user to amend their own identity records if there are any errors detected, or if the circumstances of the individual or entity changes and thereby requires an amendment to their identity records.

Prior to the general availability of the internet, people wanting or needing to use these services were required to fill out forms, and in some cases needed to mail them back to the service provider or set aside time and travel to a branch or office of the service provider so a person could meet with an authorised officer of the service provider in person. Once the relevant information was obtained and verified, the service provider often then engaged a team of data entry professionals to transfer the data from the physical form to their information management system. Not only was this a slow and inefficient procedure, it also added a lot of opportunities for errors to be introduced into the customer management system. Furthermore, errors were often slow to be detected, and slow to correct. There was other security related issues surrounding the safe handling of information as it is physically moved around within the service provider, and the proper storage and disposal of physical records and forms.

With online interactions, many of these problems are alleviated by requiring the user of these services to fill in their own personal details directly into the information management system via a web browser or smartphone app. There is no longer any requirement for data entry professionals, thereby significantly reducing the time required to enter the data, and also significantly increasing data entry and processing efficiency and security. Also, the problem of illegible and damaged forms is eliminated, and so is the need to securely store and securely dispose of processed forms. Errors are more easily noticed by the customer, and the system can easily offer the facility to enable a user to correct their own information to remove an error, or to update their information as their personal circumstances change.

However this type of impersonal interaction creates some new problems. Firstly, the veracity of the information provided, and the authenticity of any supporting information/documentation used to support at least some of the information uploaded to the information management system may be more difficult to certify as being genuine and directly relating to the individual submitting the information to the service provider. Another significant issue surrounding customer interactions, customer data input, authentication, data processing and information retrieval, is privacy. People demand privacy, and it is a legislative requirement in many jurisdictions to have systems in place that protect personal and private information. Every transaction requires a minimum amount of identity and other personal information for it to be able to progress to completion. This minimum amount of information is different for different types of transactions. For example, an application to renew a driver's license may not require any disclosure to the licensing authority of the applicant's academic qualifications. Academic qualifications would typically have no bearing on the transaction and any subsequent decision to grant or deny the application for license renewal.

There are a number of problems associated with the disparate customer management systems running across various private, non-profit and governmental service providers. Firstly, there is a lot of data duplication. Each disparate system needs to include a lot of duplicate information about a customer since it is not common for these systems to share data. Also, each system needs to maintain its own data integrity and security. However, it is only natural that not all systems are equal in this regard. Some systems are going to be better at this than others. A person's confidential information is only as secure as the weakest system on which it is stored.

In many cases, the compromise of any one system, may expose enough data about a person to effectively expose that person's data on many other systems. This has the potential to require a person to actively revisit each and every system in which they have confidential information, and update that information to accord with changes to their private information in response to the original system breach. A classic example of this would be the need to change the details of a credit card that had been compromised in a non-related system breach.

Another problem associated with the current state of affairs is the lack of transparency regarding what business or agency is utilising your data, for what purpose, and who it may have been shared with in the course of a transaction.

The present invention ameliorates at least some of the aforementioned problems by providing an identity system that will only share the relevant portions of the entire collection of data it has stored for an individual in an authorised transaction with a registered and approved third party system. Furthermore, interested individuals are able to access their official records and determine from them who has requested their personal data at any given time, so they can easily see who has been accessing their data, and for what purpose.

### DISCLOSURE OF THE INVENTION

Accordingly, the present invention is a system of providing a transaction to a person including an identity instrument, and a master database, wherein the identity instrument is issued to the person by the system under the authority of the prevailing government within a jurisdiction, and wherein the identity instrument is either virtual or physical or both, and wherein the transaction may be any governmental, commercial or charitable transaction, and wherein the master database maintains a record for each person issued with an identity instrument and when their identity instrument is used by the person, its use identifies that person's record within the master database and enables the system to retrieve the minimum amount of personal data relating to that person so that the particular transaction is able to proceed.

Preferably, the system includes a transaction portal which is physically located in a public location and is capable of receiving a person's identity instrument thereby enabling that person to identify themselves to the system and thereby being presented with a list of available transactions that are relevant to that particular person.

Alternatively, the system includes a transaction portal which is virtual, and displayed in a browser or an app on a personal computing or portable communications device, such as a smart phone, and wherein the virtual transaction portal is capable of interacting with a person's identity instrument thereby enabling that person to identify themselves to the system and thereby being presented with a list of available transactions that are relevant to that particular person

Preferably, the identity instrument only contains machine readable identity information pertaining to the person that has been issued with the instrument so that if the card was ever lost or stolen, the identity instrument provides no identification information to non-authorised persons, mitigating the likelihood that the identity instrument will be used in fraudulent activities or transactions with the system.

Preferably, the person's identity information stored in their record in the master database is periodically updated throughout the life of the person that has been issued with the particular identity instrument so that as system relevant events occur in their life, for example, opening a bank account, graduating from a particular school, getting married, their record on the master database has associated relevant information that relates to the particular event appended to the record so that the record for an individual constantly changes throughout their life as system significant events occur.

In another form, the present invention is a method of providing a transaction to a person using the system as defined in any preceding claim including:

a. creating a record in the master database that relates to a person who has had their identity verified by a relevant authority, and

b. the relevant authority then providing the person with an identity instrument, and

c. the relevant authority providing a transaction portal that is adapted to enable a person to identify themselves with the system via their identity instrument, and

d. the person then using their identity instrument to identify themselves to the system, and

e. then the relevant authority providing a myriad of transaction types across a collection of disparate services relating to government and or non-government services, and

f. then providing the person with a graphical user interface to navigate through the services available to them that are associated with their identity instrument, and

g. then once the service has been selected, and the transaction within that service has been identified by either the system or the person, the system then provides the minimum subset of personal information associated with that identity to enable the transaction to proceed.

### BRIEF DESCRIPTION OF THE DRAWING

FIG. 1 is a schematic diagram of one preferred embodiment of the present invention.

### DETAILED DESCRIPTION OF THE PREFERRED EMBODIMENTS

Every valid transaction requires identification and verification. There are a wide range of services and interactions provided by governments, other authorities and private enterprise that affect an individual person. Within these services are transactions. One example of this would be the renewal of a person's driver's license. In order for such a transaction to be valid, the system issuing the renewal of the driver's license requires the verified identity of the person applying for the renewal.

The present invention includes a master database 3 that is hosted on a computer. The master database 3 includes a record for a person 11 who has been issued with an identity instrument. It is preferred that no identification information, such as name, date of birth, address etc is contained in readable format on the instrument. This provides an additional layer of security should the instrument ever be lost or stolen. The information relating to the owner of the instrument can only be retrieved by an authorised entity. All identity information contained on the identity instrument is machine readable only. The identity instrument may be in physical form, such as a wallet or purse sized card, similar in size to a credit card, or it may be virtual, such as a digital code, such as a QR code contained on a personal electronic device, such as a computer or a smart phone.

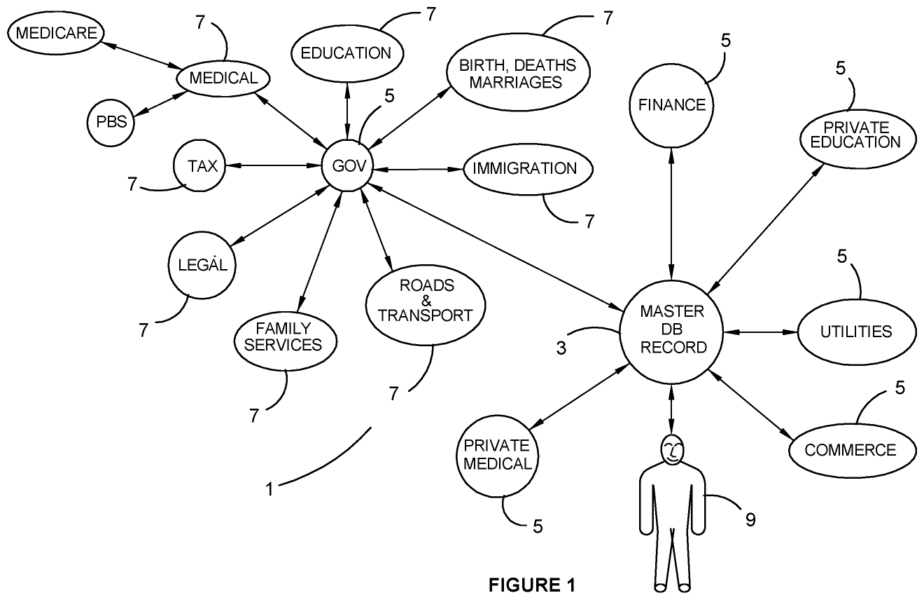

The record relating to a person 11 who has been issued with an identity instrument contains all relevant information relating to that person. Commercial services, retailers and utility companies, and the like, shown in FIG. 1 as item 5 are each able to separately interact with the system and access information from the mater database record 3. Most transactions that the person 11 will enter into will typically only ever require a subset of the total amount of personal information contained within their record on the master database record 3. Each transaction is pre-configured to only retrieve the minimum subset of personal information from the master database record 3 that is required to complete the transaction. So, in the example of the person applying to renew their driver's license, only the subset of personal information required by the driver's license issuing authority to complete the transaction is retrieved by the system from the master database record 3 for that person.

The system has wide reaching application across all facets of a person's life. The establishment of a personal record and the issuance of an identity instrument is designed to be issued to a person at birth and remain with them as they move through their life until death, appending information relating to relevant personal milestones, for example bank account details, medical records, employment records, loan details, dividend information, tax records, immigration status, marital status, criminal records and other legal related records, as they change over time.

The system includes another layer of security in the form of official and bona fide communication channels. All related transactional information for example, invoices, bill reminders, and receipts are sent through the system to the person. For a vendor 5, such as a utility company to be affiliated with the system, they must be a registered service provider. As part of their registration, the vendor's bill payment reminders, invoicing, bill payment and receipting activities are routed through the system. A person must then use the transaction portal to view their official communications from the system. The transaction portal may be accessible from a device, similar to a banking automatic teller machine (ATM) that is located in a public space, such as an office building foyer, or a shopping centre. Alternatively, the transaction portal may be contained within an app that may be installed on a personal computing device, such as a computer or a smart phone.

1. A system of providing a transaction to a person including an identity instrument, and a master database, wherein the identity instrument is issued to the person by the system under the authority of the prevailing government within a jurisdiction, and wherein the identity instrument is either virtual or physical or both, and wherein the transaction may be any governmental, commercial or charitable transaction, and wherein the master database maintains a record for each person issued with an identity instrument and when their identity instrument is used by the person, its use identifies that person's record within the master database and enables the system to retrieve the minimum amount of personal data relating to that person so that the particular transaction is able to proceed.

2. The system as defined in claim 8 wherein the system includes a transaction portal which is physically located in a public location and is capable of receiving a person's identity instrument thereby enabling that person to identify themselves to the system and thereby being presented with a list of available transactions that are relevant to that particular person.

3. The system as defined in claim 8 wherein the system includes a transaction portal which is virtual, and displayed in a browser or an app on a personal computing or portable communications device, such as a smart phone, and wherein the virtual transaction portal is capable of interacting with a person's identity instrument thereby enabling that person to identify themselves to the system and thereby being presented with a list of available transactions that are relevant to that particular person.

4.-5. (canceled)

6. A method of providing a transaction to a person using the system as defined in any preceding claim including:
a. creating a record in the master database that relates to a person who has had their identity verified by a relevant authority, and
b. the relevant authority then providing the person with an identity instrument, and
c. the relevant authority providing a transaction portal that is adapted to enable a person to identify themselves with the system via their identity instrument, and
d. the person then using their identity instrument to identify themselves to the system, and
e. then the relevant authority providing a myriad of transaction types across a collection of disparate services relating to government and or non-government services, and
f. then providing the person with a graphical user interface to navigate through the services available to them that are associated with their identity instrument, and
g. then once the service has been selected, and the transaction within that service has been identified by either the system or the person, the system then provides the minimum subset of personal information associated with that identity to enable the transaction to proceed.

7. The system as defined in claim 1 wherein the identity instrument only contains machine readable identity information pertaining to the person that has been issued with the instrument so that if the card was ever lost or stolen, the identity instrument provides no identification information to non-authorised persons, mitigating the likelihood that the identity instrument will be used in fraudulent activities or transactions with the system.

8. The system as defined in claim 7 wherein the person's identity information stored in their record in the master database is periodically updated throughout the life of the person that has been issued with the particular identity instrument so that as system relevant events occur in their life, for example, opening a bank account, graduating from a particular school, getting married, their record on the master database has associated relevant information that relates to the particular event appended to the record so that the record for an individual constantly changes throughout their life as system significant events occur.
